(19) United States
(12) Patent Application Publication
(10) Pub. No.: US 2007/0008261 A1
(43) Pub. Date: Jan. 11, 2007

(54) [BI-STABILIZED CHOLESTERIC LIQUID CRYSTAL DEVICE WITH AUTO EXECUTION FUNCTION]

(75) Inventor: Chih-Ling Wang, TAIPEI (TW)

Correspondence Address: PHISON ELECTRONICS CORPORATION, 2F-4. NO. 148, SEC. 4, CHUNG HSIAO EAST ROAD, TAIPEI, TW

(73) Assignee: PHISON ELECTRONICS CORP., Chutung Town, Hsinchu Hsien (TW)

(21) Appl. No.: 11/164,252

(22) Filed: Nov. 16, 2005

(30) Foreign Application Priority Data
Jul. 8, 2005 (TW) 094211681

(51) Int. Cl. G09G 3/36

(52) U.S. Cl. 345/87

(57) ABSTRACT

A bi-stabilized cholesteric liquid crystal device with auto execution function is disclosed. The cholestric liquid crystal device comprises a microprocessor, a cholestric liquid display device and a memory. The microprocessor is connected to a data transmission interface, a bi-stabilized cholesteric liquid crystal display device interface and a memory interface respectively. The data transmission interface is connected to a host end. The bi-stabilized cholesteric liquid crystal display device is connected to the bi-stabilized cholesteric liquid crystal display device interface and is adopted for displaying information transmitted from the microprocessor. The memory is connected to the memory interface and comprises an application program block and a data block, wherein the application program block comprises an execution program for reading data in the memory.

This application claims the priority benefit of Taiwan patent application number 094211681 filed on Jul. 8, 2005.

### BACKGROUND OF THE INVENTION

1. Field of the Invention

The present invention relates to a bi-stabilized cholesteric liquid crystal device with auto execution function, and more particularly to a bi-stabilized cholesteric liquid crystal device capable of allowing the host end to run the execution program stored in the memory and display the data stored in the memory, and also allows the user to change the information displayed in the bi-stabilized cholesteric liquid crystal display device by running the execution program.

2. Description of Related Art

With the progressive improvement in electronic technology, the electronic products such as computer, cellular phone, memory stick and digital camera are widely used in our daily life. And, increased functions of the electronic products have changed our life styles accordingly. These latest electronic products all need storage devices for saving data. Besides, the flash memory has become widely popular for its advantageous characteristics, such as non-volatile, shock proof, high density and the like. Among many portable devices, the flash memory has taken the place of EEPROM or memory requiring battery. Because the semiconductor technology is mature, it is possible to increase both the storage density and transmission speed of the flash memory, and therefore, the flash memory has gradually replaced the conventional storage media, such as the hard disk driver.

Nowadays, almost every user uses the flash memory as a storage device, and almost every electronic product contains the flash memory therein. To save data of particular interest, first, the electronic product must be turned on to find out the storage capacity or the remaining storage space available via display to give the user some idea about the storage space available and then decide which of the electronic products should be used to save the data of interest. The above-mentioned inconvenience may cause substantial amount of energy wastage and also adversely affect the service life of the electronic products due repeated turning on and off of the electronic products. Furthermore, the consumers usually purchase popular electronic products on the market; therefore several users may often have the same kind of electronic products that could easily cause misunderstandings as to the ownership. Besides, the driving program has to be installed in advance if the user desires to connect the electronic product to the personal computer or the notebook computer, and if the user happens to loose the driving program, then the connection between the electronic product and the personal computer or the notebook cannot be successful. Thus, this causes inconvenience to the user.

Furthermore, the memory stick has become a mainstream multi-media electronic product. Besides saving and portability, the memory stick can also play the MP3 music, and depending on the storage capacity, the memory stick can storage at least one hundred songs, thus the user can listen to the music anytime and anywhere. The memory stick with the music player function is similar to the CD ROM. After the memory stick is turned on, the memory stick is ready to play the first music. If the user wants to listen any particular music of interest, he must search the music by memory or recording the track position.

The technology is continuously being improved in order to satisfy the great need of the liquid crystal display, and a cholesteric liquid crystal is invented accordingly developed. The cholesteric liquid crystal is composed of nematic, and by adding the chiral molecule; the molecule of the nematic gradually rotates in an angle along an axis to form spiral structure. The spiral structure is similar to the cholesterol molecule, and that is why it is called cholesteric liquid crystal. The cholesteric liquid crystal provides the advantageous features, such as high brightness, high contrast, low power consumption, memory and Multi-Domain Vertical Alignment, and non-twinkle. The power consumption of the cholesteric liquid crystal is 1/50 or less than the conventional LCD. Such cholesteric liquid crystal only consumes power when the crystal orientation changes for displaying. In other words, when the display is still, no power will be consumed. Therefore, the cholesteric liquid crystal is capable of continuously displaying the last picture without consuming any power, and even when the power supply to the cholesteric display is cut off.

With the above advantages of the cholesteric liquid crystal, it is highly desirable to apply the cholesteric liquid crystal with auto execution function in the electronic products.

### SUMMARY OF THE INVENTION

Accordingly, in the view of the foregoing, the present inventor makes a detailed study of related art to evaluate and consider, and uses years of accumulated experience in this field, and through several experiments, to create a bi-stabilized cholesteric liquid crystal device with auto execution function.

According to an aspect of the present invention, the memory comprises the application program block and the data block, wherein the application program block comprises the execution program for reading data stored in the memory. Thus, as the bi-stabilized cholesteric liquid crystal device is connected to the host end, the host end can automatically run the execution program stored in the application program block of the memory to enable the user to operate without installing any drive program. Besides, the host end can calculate the capacity of the data block of the memory through the execution program to display the calculating result, and the calculating result can also be transmitted to bi-stabilized cholesteric liquid crystal display device for displaying.

According to another aspect of the present invention, the execution program is adopted for retrieving and transmitting the information stored in the memory to the bi-stabilized cholesteric liquid crystal display device for displaying. Thus, the user would be able to learn the last status of the bi-stabilized cholesteric liquid crystal device before turned on for subsequent use. The execution program may also transmit the on-time capacity of the memory to the bi-stabilized cholesteric liquid crystal display device for displaying during the operation.

According to another aspect of the present invention, the user may use the execution program to choose the panel of the bi-stabilized cholesteric liquid crystal display device and the content in varieties and personalized form for identifying.

According to another aspect of the present invention, the microprocessor of the bi-stabilized cholesteric liquid crystal device is adopted for controlling the content displayed in the bi-stabilized cholesteric liquid crystal display device so that operation of the host end for calculating may be avoided which would otherwise reduces the efficiency.

### BRIEF DESCRIPTION OF THE DRAWING

FIG. 1 is a block diagram of a bi-stabilized cholesteric liquid crystal device according to a preferred embodiment of the present invention.

FIG. 2 is a flowchart illustrating a procedure of an initialization process according to an embodiment of the present invention.

FIG. 3 is a flowchart illustrating a procedure of calculating capacity of the memory according to an embodiment of the present invention.

FIG. 4 is a flowchart illustrating a procedure of changing the display of the bi-stabilized cholesteric liquid crystal display device according to an embodiment of the present invention.

### DETAILED DESCRIPTION OF EMBODIMENTS

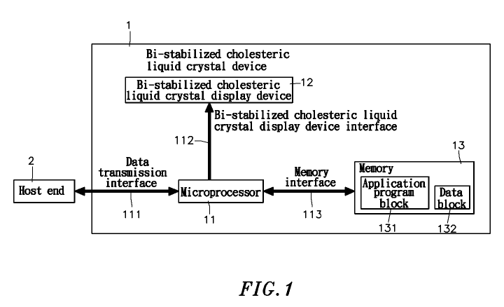

Referring to FIG. 1, a bi-stabilized cholesteric liquid crystal device 1 in accordance with the present invention is shown comprised of a microprocessor 11, a bi-stabilized cholesteric liquid crystal display device 12 and a memory 13.

The microprocessor 11 is connected to a data transmission interface 111, a bi-stabilized cholesteric liquid crystal display device interface 112 and a memory interface 113 respectively. The data transmission interface 111 is adopted for connecting to a host end 2, and the microprocessor 11 is comprised of a 8015, DSP or ARM structure.

The bi-stabilized cholesteric liquid crystal display device 12 is connected to the bi-stabilized cholesteric liquid crystal display interface 112 of the microprocessor 11. The bi-stabilized cholesteric liquid crystal display device 12 comprises a dot matrix or a 7-segment display device, capable displaying information transmitted from the microprocessor 11.

The memory 13 is connected to the memory interface 113 of the microprocessor 11 and comprises an application program block 131 and a data block 132. The application program block 131 is adopted for storing an execution program for enabling reading data in the memory 13. The memory 13 may comprise NAND, AND or AG-AND flash memory, or a hard disk, micro-drive or compact flash (CF) card. The application program block 131 may be comprised of a ISO9660 format, and the data block 132 may be comprised of a file allocation table (FAT) format or NT file system (NTFS) format.

The abovementioned memory 13 is merely adopted for storing the execution program and the data that a user desires to save, and any structure equivalent to the memory 13 is within the scope of the present invention.

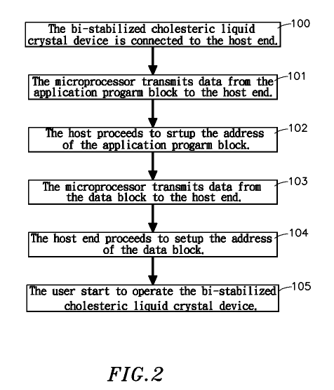

Referring to FIG. 2, an initialization process of the present invention may be described as follows.

At step 100, the bi-stabilized cholesteric liquid crystal device 1 is connected to the host end 2.

At step 101, the microprocessor 11 transmits data from the application program block 131 to the host end 2.

At step 102, the host end 2 proceeds to setup an address of the application program block 131.

At step 103, the microprocessor 11 transmits data from the data block 132 to the host end 2.

At step 104, the host end 2 proceeds to setup an address of the data block 132.

At step 105, a user may start to operate the bi-stabilized cholesteric liquid crystal device 1.

Accordingly, as the bi-stabilized cholesteric liquid crystal device 1 is connected to the host end 2 for the first time via the data transmission interface 111, the bi-stabilized cholesteric liquid crystal device 1 uses the microprocessor 11 to transmit data stored in the application program block 131 to the host end 2, and when the host end 2 completes setting up the address of the application program block 131, the microprocessor 11 transmits data stored in the data block 132 to the host end 2 and the host end 2 also completes the setting up of the address of the data block 132. Once the host end 2 completes setting up the address for the application program block 131 and the data block 132, the user may start to operate the bi-stabilized cholesteric liquid crystal device 1 to retrieve from/save to the memory 13.

The abovementioned host end 2 may be a computer, a notebook computer or a personal digital assistant (PDA), and the bi-stabilized cholesteric liquid crystal device 1 may be a portable disk or a MP3 player. Furthermore, the data transmission interface 111 may be a USB transmission interface, a SATA transmission interface or a PCI transmission interface. The bi-stabilized cholesteric liquid crystal display device interface 112 may be a parallel protocol or a serial protocol, and the memory interface 113 may be a NAND flash interface, a SATA transmission interface or a compact flash (CF) card interface.

If the user uses the bi-stabilized cholesteric liquid crystal device 1 to play MP3 music, the bi-stabilized cholesteric liquid crystal display device 12 can retrieve relative music information through the execution program and displays the information so that the user can search easily during the subsequent operation. Thus, the user may be able to learn whether the bi-stabilized cholesteric liquid crystal device 1 was previously used by others by checking the displayed information in the bi-stabilized cholesteric liquid crystal display device 12.

When the bi-stabilized cholesteric liquid crystal device 1 is connected to the host end 2 through the data transmission interface 111 again, the user would be able operate the host end 2 to retrieve/save data from/to the data block 132 of the memory 13 via the memory interface 113 of the microprocessor 11. Meanwhile, the bi-stabilized cholesteric liquid crystal device 1 informs the host end 2 with auto run function, and the host end 2 can automatically run the execution program stored in the application program block 131 of the memory 13 and issues a reading command through the execution program to read the present status of the bi-stabilized cholesteric liquid crystal device 1, for example, the partition table. Accordingly, by running the execution program, the disk label, the total capacity, the used capacity and the last usage time and the data of the data block 132 of the memory 13 can be learned from the bi-stabilized cholesteric liquid crystal display device 12 controlled by the microprocessor 11. Besides, because the bi-stabilized cholesteric liquid crystal display device 12 is capable of displaying the last picture even after the power supply is cut off, therefore the user would be able to easily learn the last usage data and the time, the disk label, the total capacity, the used capacity and other information.

Furthermore, when using the bi-stabilized cholesteric liquid crystal device 1, the capacity of the data block 132 of the memory 13 changes according to the operation, at the same time, the host end 2 continuously calculates the capacity of the data block 132 of the memory 13 through the execution program and displays a calculating result. The calculating result can also be transmitted to the microprocessor 1 to renew display information in the bi-stabilized cholesteric liquid crystal display device 12 accordingly. Thus, the user would be able to learn the capacity of the data block 132 of the bi-stabilized cholesteric liquid crystal device 1. Besides, because the power consumption of the bi-stabilized cholesteric liquid crystal display device 12 is much less compared to the conventional liquid crystal display device, the bi-stabilized cholesteric liquid crystal display device 12 can substantially reduce the energy consumption and accordingly reduce the operation cost. The microprocessor 11 of the bi-stabilized cholesteric liquid crystal device 1 is adopted for controlling the bi-stabilized cholesteric liquid crystal display device 12 to display information without going through the calculation of the host end 2 so that the operation of the host end 2 for calculating may be avoided which would otherwise reduces the efficiency.

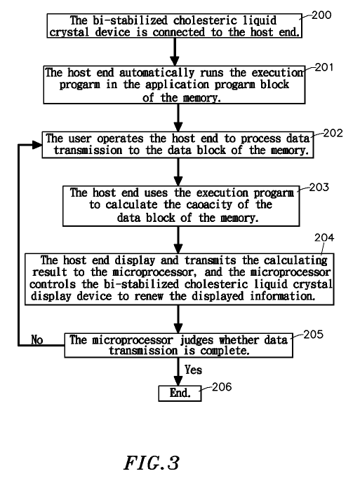

Referring to FIG. 3, a procedure of calculating capacity of the memory of the present invention may be described as follows.

At step 200, the bi-stabilized cholesteric liquid crystal device 1 is connected to the host end 2.

At step 201, the host end 2 automatically runs the execution program stored in the application program block 131 of the memory 13.

At step 202, the user can operate the host end 2 to process data transmission to the data block 132 of the memory 13.

At step 203, the host end 2 uses the execution program to calculate the capacity of the data block 132 of the memory 13.

At step 204, the host end 2 displays the calculating result and transmits the result to the microprocessor 11, and the microprocessor 11 controls the bi-stabilized cholesteric liquid crystal display device 12 to renew the displayed information.

At step 205, the microprocessor 11 judges whether the data transmission is complete, if yes, the procedure proceeds to step 206; otherwise the procedure proceeds to step 202.

At step 206, the procedure ends.

The user may also input the user's information, for example, name, graphics, text or the like, by using an input device of the host end 2 to run the execution program, and the microprocessor 11 is used to display the information in the bi-stabilized cholesteric liquid crystal display device 12. Thus, the bi-stabilized cholesteric liquid crystal display device 12 can be applied as the built-in label for the bi-stabilized cholesteric liquid crystal device 1 so that when different users have the same bi-stabilized cholesteric liquid crystal device 1, the ownership of the bi-stabilized cholesteric liquid crystal device 1 can be easily identified and thereby avoid misunderstandings. The execution program also allows pictures or animation, which is downloaded by the programmer or the user, to be displayed in the bi-stabilized cholesteric liquid crystal display device 12 while the bi-stabilized cholesteric liquid crystal device 1 is in the sleep mode to notify the user, thus making the product attractive the users.

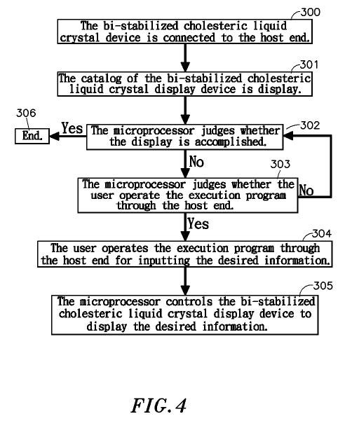

Referring to FIG. 4, a procedure of changing the display in the bi-stabilized cholesteric liquid crystal display device is as follows.

At step 300, the bi-stabilized cholesteric liquid crystal device 1 is connected to the host end 2.

At step 301, a catalog of the bi-stabilized cholesteric liquid crystal display device 12 is display.

At step 302, the microprocessor 11 judges whether the display is accomplished, if yes, the procedure proceeds to step 306; otherwise, the procedure proceeds to step 303.

At step 303, the microprocessor 11 judges whether the user operates the execution program through the host end 2, if yes, the procedure proceeds to step 304; otherwise, the procedure proceeds to step 302.

At step 304, the user operates the execution program through the host end 2 for inputting the desired information.

At step 305, the microprocessor 11 controls the bi-stabilized cholesteric liquid crystal display device 12 to display the desired information.

At step 306, the procedure ends.

Accordingly, the bi-stabilized cholesteric liquid crystal device with auto execution function of the present invention has at least the following advantages.

1. The memory 13, according to the present invention comprises the application program block 131 and the data block 132, and the application program block 131 stores the execution program for reading the data in the memory 13, and therefore when the bi-stabilized cholesteric liquid crystal device 1 is connected to the host end 2, the host end 2 automatically runs the execution program in the application program block 131 of the memory 13 to enable the user to use without the installation of any driver program.

2. The execution program is used to retrieve the data in the memory 13, and the microprocessor 11 is adopted for controlling the bi-stabilized cholesteric liquid crystal display device 12 to display the data. Thus, the user may be able to learn the last status information before using the bi-stabilized cholesteric liquid crystal device 1 for the next time.

3. The execution program is used to calculate the capacity of the data block 132 of the memory 13, and the microprocessor 11 is adopted for renewing the information displayed in the bi-stabilized cholesteric liquid crystal display device 12 so that the user may be able to learn the capacity of the data block 132 of the bi-stabilized cholesteric liquid crystal device 1.

4. The user can operate execution program to input any desired information, and the microprocessor 11 is adopted for controlling the bi-stabilized cholesteric liquid crystal display device 12 to display the information. Thus, the bi-stabilized cholesteric liquid crystal display device 12 may be used as a built-in label of the bi-stabilized cholesteric liquid crystal device 1 to display the information in varieties and personalized forms for identification purpose.

5. The bi-stabilized cholesteric liquid crystal display device 12 is used as the display device, and the operation power consumption is substantially less than the conventional LCD. Therefore, the operation cost of the bi-stabilized cholesteric liquid crystal display device 12 is substantially reduced.

6. The microprocessor 11 of the bi-stabilized cholesteric liquid crystal device 1 is adopted for controlling the information displayed in the bi-stabilized cholesteric liquid crystal display device 12 without going through the calculation process of the host end 2. Thus, the operation of the host end 2 for calculating may be avoided which would otherwise reduces the efficiency.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A bi-stabilized cholesteric liquid crystal device with auto execution function, comprising:
a microprocessor, connected to a data transmission interface, a bi-stabilized cholesteric liquid crystal display device interface and a memory interface respectively, wherein said data transmission interface is connected to a host end;
a bi-stabilized cholesteric liquid crystal display device, connected to said bi-stabilized cholesteric liquid crystal display device interface, for displaying information transmitted from said microprocessor; and
a memory, connected to said memory interface, comprising an application program block and a data block, wherein said application program block comprises an execution program for reading data in said memory.

2. The bi-stabilized cholesteric liquid crystal device with auto execution function according to claim 1, wherein said host end calculates a capacity of said data block of said memory through said execution program, and said execution program sends a calculating result to said host end and said bi-stabilized cholesteric liquid crystal display device for displaying.

3. The bi-stabilized cholesteric liquid crystal device with auto execution function according to claim 1, wherein said bi-stabilized cholesteric liquid crystal display device interface comprises a parallel protocol.

4. The bi-stabilized cholesteric liquid crystal device with auto execution function according to claim 1, wherein said bi-stabilized cholesteric liquid crystal display device interface comprises a serial protocol.

5. The bi-stabilized cholesteric liquid crystal device with auto execution function according to claim 1, wherein said memory interface comprises a NAND flash interface.

6. The bi-stabilized cholesteric liquid crystal device with auto execution function according to claim 1, wherein said memory interface comprises a SATA interface.

7. The bi-stabilized cholesteric liquid crystal device with auto execution function according to claim 1, wherein said memory interface comprises a compact flash (CF) card interface.

8. The bi-stabilized cholesteric liquid crystal device with auto execution function according to claim 1, wherein said data transmission interface comprises a USB transmission interface.

9. The bi-stabilized cholesteric liquid crystal device with auto execution function according to claim 1, wherein said data transmission interface comprises a SATA transmission interface.

10. The bi-stabilized cholesteric liquid crystal device with auto execution function according to claim 1, wherein said microprocessor is comprised of an 8051 structure.

11. The bi-stabilized cholesteric liquid crystal device with auto execution function according to claim 1, wherein said microprocessor is comprised of a DSP structure.

12. The bi-stabilized cholesteric liquid crystal device with the auto execution function according to claim 1, wherein said microprocessor is comprised of an ARM structure.

13. The bi-stabilized cholesteric liquid crystal device with auto execution function according to claim 1, wherein said bi-stabilized cholesteric liquid crystal display device comprises a dot matrix display device.

14. The bi-stabilized cholesteric liquid crystal device with auto execution function according to claim 1, wherein said bi-stabilized cholesteric liquid crystal display device comprises a 7-segment display device.

15. The bi-stabilized cholesteric liquid crystal device with auto execution function according to claim 1, wherein said memory comprises a NAND flash memory.

16. The bi-stabilized cholesteric liquid crystal device with auto execution function according to claim 1, wherein said memory comprises an AND flash memory.

17. The bi-stabilized cholesteric liquid crystal device with auto execution function according to claim 1, wherein said memory comprises a compact flash (CF) card.

18. The bi-stabilized cholesteric liquid crystal device with auto execution function according to claim 1, wherein said application program block is comprised of an ISO9660 format.

19. The bi-stabilized cholesteric liquid crystal device with auto execution function according to claim 1, wherein said data block is comprised of a file allocation table (FAT) format.

20. The bi-stabilized cholesteric liquid crystal device with auto execution function according to claim 1, wherein said data block is comprised of a NT file system (NTFS) format.
